(19) United States
(12) Patent Application Publication
(10) Pub. No.: US 2007/0258443 A1
(43) Pub. Date: Nov. 8, 2007

(54) Switch hardware and architecture for a computer network

(75) Inventors: Joseph I. Chamdani, Santa Clara, CA (US); Raj Cherabuddi, Saratoga, CA (US); Michael Corwin, Sunnyvale, CA (US); Yu Fang, Sunnyvale, CA (US); Joseph E. Pelissier, Hillsboro, OR (US)

Correspondence Address: HENSLEY KIM & HOLZER, LLC, 1660 LINCOLN STREET, SUITE 3000, DENVER, CO, 80264, US

(73) Assignee: McDATA Corporation

(21) Appl. No.: 11/417,075

(22) Filed: May 2, 2006

(51) Int. Cl. H04L 12/50

(52) U.S. Cl. 370/386; 370/463

(57) ABSTRACT

A method, system or switch device, the switch device being one of a ported and a non-ported switch device, both including a housing containing an ASIC providing a switching system within the switch device; the housing further including a plurality of extender ports communicating with the ASIC and being connectable to themselves either in loopback fashion or to one or more ported or non-ported switch devices, whereby the extender ports operate on a discrete protocol from standard switch ports. The ported switch device further includes a plurality of standard ports connectable to one or more external computer network devices and is adapted to be operable as a switch system in an independent standalone mode as well as being adapted to be operable in conjunction with a discrete non-ported switch device.

### TECHNICAL FIELD

This invention relates generally to computer networks such as storage area networks, and more particularly to the hardware of one or more switches and the architecture of a switch system created by modular components.

### BACKGROUND

A computer storage area network (SAN) may be implemented as a high-speed, special purpose network that interconnects one or more or a variety of different data storage devices with associated data servers on behalf of an often large network of users. Typically, a storage area network is part of or otherwise connected to an overall network of computing resources for an enterprise. The storage area network may be clustered in close geographical proximity to other computing resources, such as mainframe computers, or it may alternatively or additionally extend to remote locations for various storage purposes whether for routine storage or for situational backup or archival storage using wide area network carrier technologies.

SANs or like networks can be complex systems with many interconnected computers, switches and storage devices. Often many switches are used in a SAN or a like network for connecting the various computing resources; such switches also being configurable in an interwoven fashion also known as a fabric.

Various limitations in switch hardware and switch architecture have been encountered. These can, for example, be size and scalability limits, as for example where there can be interconnectability limits due, for example, to conventional chassis size limitations. In more detail, a chassis size issue can be attributed to certain hardware limits, some conventional devices currently providing for maximum numbers of switch devices to be connected therein. These limits may be based upon physical hardware issues within a constrained chassis arrangement, as for example, issues related to the provision of appropriate minimum power and/or cooling to the switches disposed or to be disposed within a particular chassis.

In one configuration, switches are assembled in a chassis using a selection of blade components. Individual blade components are fitted into slots in the chassis and connected to a chassis backplane for interconnectivity. For example, line card blades, switch blades, and other blade components can be inserted into a chassis to provide a scalable and customizable storage network switch configuration. Typically, the blades are controlled by shared control processors (e.g., one active and one backup), powered by one or more shared power supplies through the backplane, and cooled by a shared set of cooling fan trays.

However, adding blades in a chassis presents significant limitations. A chassis has a limited number of slots, and a SAN administrator may not have an open slot in which to add a further switch blade. Even with an available slot, an additional switch blade adds additional risk to the core switch system, reducing the overall mean-time-between-failures (MTBF). More devices mean more failure potential or lessened reliability. Further, some switch blades may tend to run hotter than other switch blades and therefore require placement in the better-cooled slots in the chassis. If such slots are already occupied by other blades, addition of an intelligent service blade can disrupt service as the other blades are moved around in the chassis. A chassis backplane also has power and signaling constraints that can restrict the scalability of a switch system.

### SUMMARY

Implementations described and claimed herein address these problems by providing improvements in methods, systems, hardware and/or architecture of computer or communication network systems. Briefly stated, a primary hardware improvement is in the provision of a discrete switch device, namely, a ported switch device that provides user ports and basic switching, and which is adapted to be operable as a basic switch system in an independent standalone fashion as well as being adapted to be operable in conjunction with a discrete ported or non-ported switch device. In further detail, provided here is a method, system or switch device, the switch device being one of a ported and a non-ported switch device, both of which being adapted to provide switching functions and the ported switch device providing user ports for connection to external devices, the non-ported switch device not including such external device connection ports. Moreover, either of the ported or non-ported switch devices hereof includes a housing containing an ASIC creating a switching system within the switch device; the housing further including a plurality of extender ports communicating with the ASIC and being connectable to themselves in loopback fashion or to one or more ported or non-ported switch devices, whereby the extender ports operate on a discrete protocol from standard ports. The ported switch device further includes a plurality of standard ports connectable to one or more external computer network devices and is adapted to be operable as a switch system in an independent standalone mode as well as being adapted to be operable in conjunction with a discrete non-ported switch device. Moreover, identification communication may be provided via the extender ports to enable the determination of any operable connection or absence of connection of the extender ports either to themselves in loopback fashion or to one or more discrete ported or non-ported switch devices.

Alternatively, the present invention may involve a method for managing a switch system containing one or more ported switch devices and zero or more non-ported switch devices, the method including discovering one or more ported or non-ported switch devices via any connections extant therebetween; and operating the switch system; wherein the operating of the switch system includes one of operating one of the one or more ported switch devices in an independent standalone mode and operating the one or more ported switch devices in conjunction with the zero or more non-ported switch devices.

The technology hereof increases the flexibility of use of one or more switch devices as well as improving the management of a switch system including the creation, reconfiguration and maintenance of a switch system. Other implementations are also described and recited herein.

### BRIEF DESCRIPTIONS OF THE DRAWINGS

In the drawings:

FIG. 1 illustrates an exemplary computing and storage framework which may include a local area network (LAN) and a storage area network (SAN).

FIG. 2 illustrates a portion of an exemplary network particularly including a plurality of switch devices.

FIG. 3, which includes sub-part FIGS. 3A, 3B and 3C, illustrates further portions of exemplary networks particularly including one or a plurality of switch devices.

FIG. 4 illustrates yet one further portion of an exemplary network particularly including a plurality of switch devices.

FIG. 5 is a schematic view of some operable components within a switch device.

FIG. 6 is a further schematic view of some operable components within an alternative switch device.

FIG. 7 is a process diagram depicting another implementation of the described technology.

### DETAILED DESCRIPTION

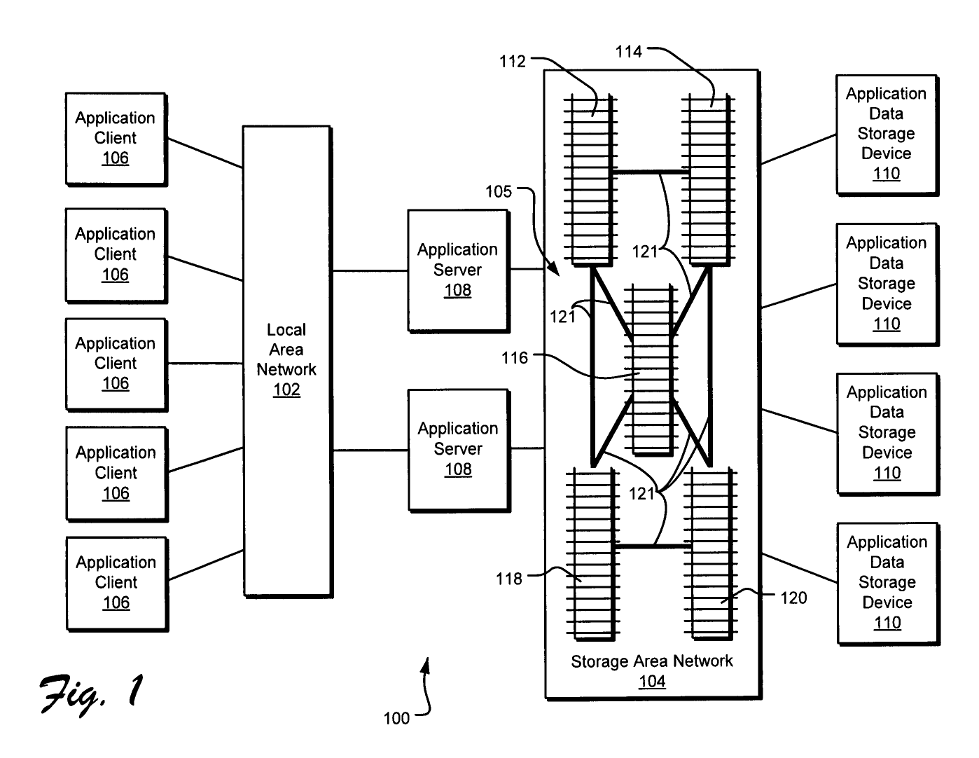

FIG. 1 illustrates an exemplary computing and storage framework 100 including a local area network (LAN) 102 and a storage area network (SAN) 104. Various application clients 106 are networked to representative application servers 108 via the LAN 102. Users can access applications resident on the application servers 108 through the application clients 106. The applications may depend on data (e.g., an email database) stored at/on one or more of the respective application data storage devices 110. Accordingly, the SAN 104 provides connectivity between the application servers 108 and the application data storage devices 110 to allow the applications to access the data they need to operate. It should be understood that a wide area network (WAN) may also be included on either side of the application servers 108 (i.e., either combined with the LAN 102 or combined with the SAN 104).

One or more switches may be used in a network hereof, as for example the plurality of switches 112, 114, 116, 118 and 120 shown in the SAN 104 in FIG. 1. These switches 112-120 are often interconnected to provide a distributed redundant path configuration. Such distributed interconnections, identified generally as interconnections 121 in FIG. 1, create what may be referred to as a fabric 105. Each of the various switches may be connected in redundant manners via plural interconnections 121 to respective pluralities of other switches to ensure that if any particular connection between switches is not active for any reason, then a redundant path may be provided via the other connections and the other switches. Accordingly, such a distributed architecture of the fabric 105 can thus facilitate load balancing, enhance scalability, and improve fault tolerance within any particular switch.

Note, though only one fabric 105 is shown and described, many fabrics may be used in a SAN, as can many combinations and permutations of switches and switch connections. Commonly, such networks may be run on any of a variety of protocols such as the protocol known as Fibre Channel. These fabrics may also include a long-distance connection mechanism (not shown) such as asynchronous transfer mode (ATM) and/or Internet Protocol (IP) connections that enable sites to be separated by arbitrary distances.

Herein, the switches and/or the switching functions thereof are addressed as these reside within overall switch devices, particularly switch devices which have adaptabilities for operation in alternative or simultaneous discrete modes. Such adaptabilities may be in the form of intelligence or other capabilities within the switch device to selectively operate in either or both of two discrete modes. Moreover, each of the switch devices, e.g., each of switch devices 112-120 can be provided in a modular form for operability in the alternative modes, the modular form providing for standalone independent operation, as well as a stackable or rackable module or device configuration for interconnected operability as described further below.

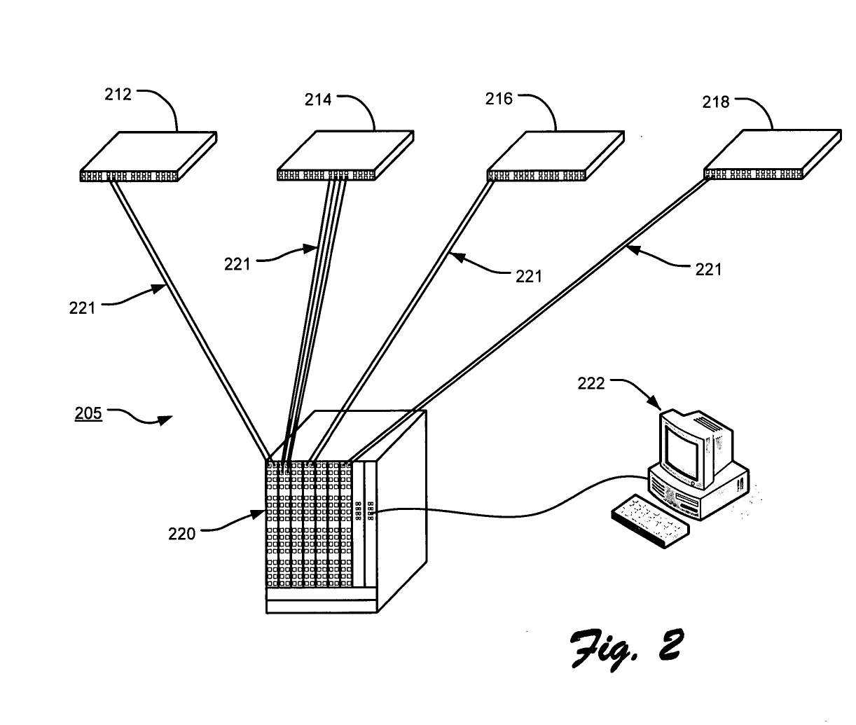

FIG. 2 illustrates exemplary multiple intelligent switch devices 212, 214, 216, and 218 hereof connected to a chassis-based director-level switch device 220. A switch system 205 may thus be created. Fibre Channel ports of each intelligent switch device 212, 214, 216, and 218 are connected to Fibre Channel ports in the switch device 220 by optical cabling 221 (although wired cabling, such as copper cabling, may alternatively be employed). Each illustrated switch device may have separate power supplies and cooling mechanisms, although individual switch devices may share power supplies and/or cooling mechanisms in alternative configurations.

In some implementations, a management client 222 may be connected to the director switch device 220 via an Ethernet connection. Other connection mechanisms and/or systems such as a typical serial connection or in-band management connection may alternatively be used if such a management client is connected to a switch device. The management client 222 may then provide user control and monitoring of various aspects of the switch device and other attached devices, including without limitation, zoning, security, firmware, routing, addressing, etc. The management client 222 can send or receive a management request to or from any or all switches, and the director switch device 220 will perform whatever portion of the requested management function it is capable of performing (if any) and forward instructions to the attached switch device possessing the referenced port for additional activity, if necessary.

An intelligent switch device according hereto provides user ports and basic switching. Such a switch device will also be referred to as a ported switch device herein. As introduced above, in one implementation, a single ported switch device may operate as a stand-alone switch. In an alternative implementation, multiple ported switch devices may be interconnected via extender ports to provide a switch system with a larger number of user ports. Interconnection by extender ports avoids consumption of the device's user ports and therefore enhances the scalability of the switch system. As described further below, another device particularly useful with a ported switch device hereof is a switch device without standard or conventional ports and is thus referred to as an unported or a non-ported switch device herein. Such a non-ported switch device provides non-blocking interconnection with ported switch devices and other types of devices or modules via extender ports which are typically non-standard or non-conventional ports. Use of such non-standard extender ports may provide non-standard high performance relative to what may be provided by a standard port protocol (e.g., Fibre Channel) which would have a blocking interconnection. Such non-standard ports may be used in a variety of connection schemes; whether in loopback connections of a device to itself, whether between ported switch devices (also referred to as a stackable configuration) or between ported and unported switch devices (also referred to as a rackable configuration). Though not typical, connections may in some alternatives be made between and amongst ported switch devices as well as between and/or amongst unported switch devices.

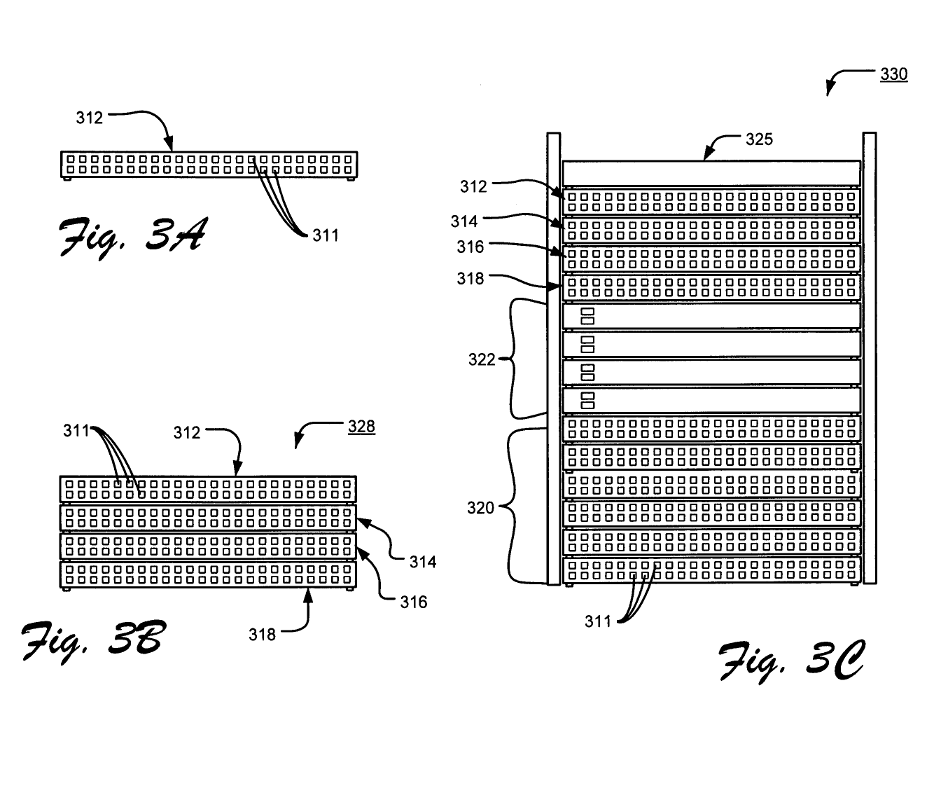

A view with switch devices 312-320 like the switch devices 212-218 of FIG. 2 is shown in the sub-part FIGS. 3A, 3B and 3C of FIG. 3. In a first example, a single ported switch device 312 is shown in FIG. 3A in a standalone independent operative configuration. As described below, such a switch device 312 has the capability of acting as a substantially basic switch system and has a plurality of standard ports 311 for connection to network devices such as the application servers 108 and the application data storage devices 110 of FIG. 1. In a further example as shown in FIG. 3B, a plurality of the same sorts of ported switch devices 312-318 are shown connected to each other in an operable stack 328. Then, in a still further example as shown in FIG. 3C, ported switch devices 312-318 are shown connected to other switch devices 320 and 322 (devices 320 and 322 are multiple devices identified as groups only, they may be independently and/or separably operable as well) in a rack 330 which may also be referred to as a director 330. Each of these operational orientations may thus provide a system of switching alternatives for use in a computer network. Note, the switch devices used as building blocks for any of these operational examples may also be referred to as modules, in either case, the switch devices and or modules generally being respective enclosed packages that may be independently operable (as for example, being capable of providing their own cooling and their own power), as opposed to switches in a blade form, which are dependent for operability on a chassis (as e.g., for cooling and power).

In more detail, FIG. 3C illustrates a rack 330 of exemplary modular switch devices 312-322 which may be used in a SAN or like computer network. The rack 330 hereof includes two types of switch devices, particularly the ported switch devices 312-320 and the un-ported switch devices 322. The illustration shows an alternative configuration in which the blade-and-chassis switch is replaced with multiple ported switch devices and un-ported switch devices, which can be connected via cabling to each other. The switch system illustrated in FIG. 3C, therefore takes the form of a racked combination of switch devices (e.g., ported switch devices 312-320 and non-ported switch devices 322), in which the non-ported switch devices provide an interconnection system for the ported switch devices without consuming the user ports of the ported switch devices.

In an implementation hereof, the ported switch devices 312-320 can connect to each other as well as to the un-ported switch devices 322 via cabling to extender ports (which are discrete and different from the standard user ports 311 shown in FIG. 3) in what in the shown implementations are the backs of the switch devices 312-320. Such cabling replaces the chassis hardware backplane or midplane connection board, and as such may be referred to herein as a “soft backplane.”

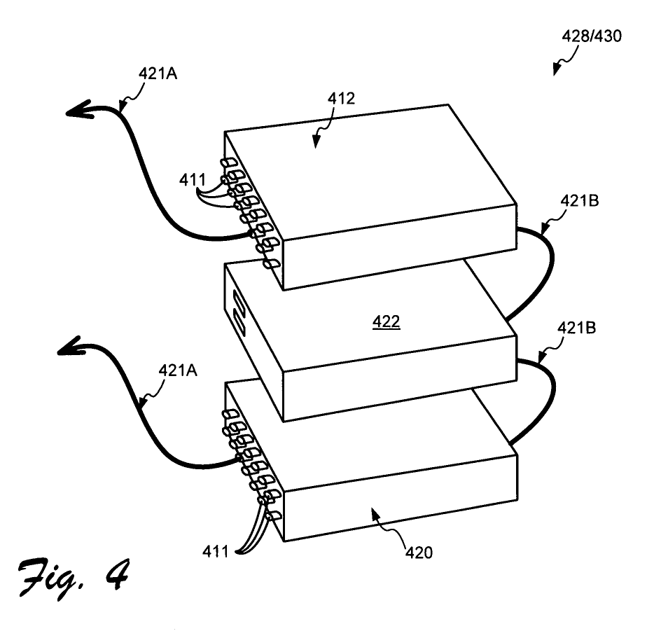

An exemplary front and back connection scheme is shown in FIG. 4 where in the stack/rack 428/430, a non-ported switch device 422 is shown connected to a respective two ported switch devices 412 and 420. These connections are shown via the cables 421B at the respective rear sides of the devices 412, 420 and 422. This is in contradistinction of the substantially conventional ported connections 421A of the ported switch devices 412 and 420 through the front ports 411. The front ports 411 may be operable in a conventional or standardized protocol such as the Fibre Channel protocol. The unshown ports connected by cables 421B may be operable using an alternative non-standardized protocol. Such an alternative connection scheme by cables 421B may also be referred to as a soft backplane.

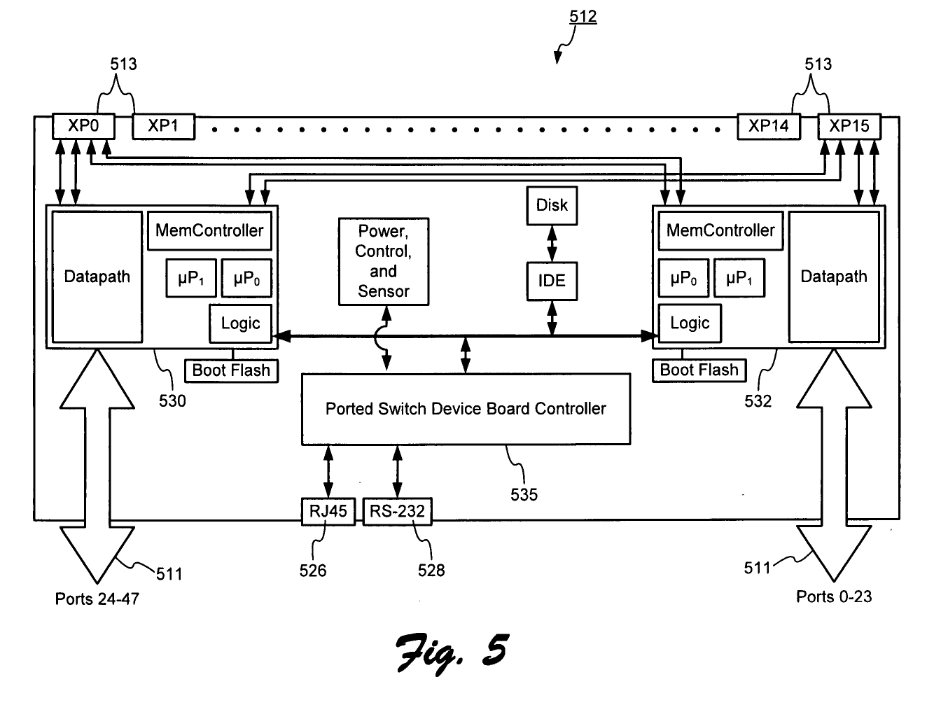

A further optional switch service device 325 is shown also in FIG. 3C, such a service device being operable in any of many ways not further explored here. In one implementation, when one or more service device(s) 325 may be used, the service device(s) 325 may connect to one or more of the switch devices 312-320 and 322 via cabling (not shown) to ports such as the RJ45 ports (see FIG. 5 below) on the fronts of the devices and to the unported switch devices 322, either in one configuration to a service bus such as an RJ45 port, or in another configuration on the back sides of the devices through an in-band port. The front side RJ45 or like ports on the ported and unported switch devices may be used for the service device 325 to provide maintenance functions or communications (slower, any-to-many, port connections such as provided RJ45 connections may be sufficient for such maintenance functions). Alternatively, one or more service devices 325 can connect via cabling to backplane extender ports in the back of the switch devices 312-320 (see FIG. 4), particularly to unported switch devices 322 so as to provide traffic control functionality through the higher speed extender ports thereof. One further alternative is that the maintenance function can be performed by any switch device (assume or share the role of a service device), and can make these service communications via the extender ports.

In any or all of the examples of FIGS. 2, 3 or 4, the ported switch devices 212-220, 312-320 or 412-420 may act or at least may have a capability of acting in an independent fashion as a system in and of themselves as well as having the capability of fully interconnecting either with other ported switch devices or with non-ported switch devices, such as those non-ported switch devices 322 and 422 shown in FIGS. 3C and 4. At the macroscopic level, a contribution to the capability for providing either stand-alone independent functionality or combined functionality or both may be attributed to the modularized packaging; namely the self-contained nature of the switch devices themselves. Provided in such a fashion, a ported switch device may be fully operational as a standalone device as is device 312 in FIG. 3A, or may be stacked or racked together with other ported switch devices or non-ported switch devices as shown in FIGS. 3B, 3C and 4.

The making of the ported switch device operational in either a standalone mode or in the interconnected mode involves an adaptation of a ported switch device such that it will perform auto- or self-discovery. Typically, self-discovery involves the ability of a switch device to determine what devices, if any, it may be connected to so it will then know how to operate. In particular, discovery messages may be sent and/or received and negotiations can take place via the connections, particularly via the soft backplane connections (see cables 421B in FIG. 4), between connected devices whereupon the ported switch device can then determine whether the connection is a valid connection for either the standalone mode (loopback or other standalone connections can be used for standalone mode) or for interconnected operation with either other ported switch devices or non-ported switch devices or both.

Reaching these determinations and/or these altered operational states may be implemented through use of one or more components within the ported switch device. FIG. 5 schematically illustrates an exemplary ported switch device 512, which in this implementation includes forty-eight (48) user ports 511 (also referred to as front ports) and sixteen (16) extender ports 513 (also referred to as X ports-XP00 through XP15). The ported switch device 512 may also support a management Ethernet interface 526 (RJ45) and/or a serial interface 528 (RS-232). Internally, the ported switch device 512 includes at least one Application Specific Integrated Circuit (ASIC), here shown including two such switch ASICs 530 and 532, wherein each ASIC may include, though not necessarily, one or more embedded microprocessors, here shown including two such individual embedded processor cores, a port intelligence processor (PIP) and a high level processor (HLP) (e.g., 666 MHz PowerPC 440SPs or some other processor core), these being arbitrarily designated μP0 and μP1 in each of the ASICs of FIG. 5. The processors may share access to common DRAM and flash memory through the illustrated memory controller in each ASIC. Note, the microprocessor(s) may be disposed inside, as shown, or outside the ASIC. A device board controller 535 may also be included to manage any arbitration between the ASICs and/or to manage ancillary functions such as a device control Ethernet port, or other interface control, display, status LEDs (front and/or back), Real Time Clock (RTC), and/or Vital Product Data (VPD) EEPROM. The ported switch device may also include a power supply and cooling features (e.g., one or more fans), although alternative configurations may receive power from a common (i.e., shared with one or more other devices) power supply and/or receive cooling from a common cooling feature. The device board controller may also control these power and cooling features (e.g., power-on reset events, power failure interrupts, fan speed and the like). The “Power, Control, and Sensor” block shown in FIG. 5 may include power management circuitry, temperature/voltage sensors, and other board control functions for these purposes. Similarly, the disk and/or IDE controller blocks may operate with the Port module board controller to provide non-volatile storage. The ported switch device board controller may also provide low level board management for interfacing with the ASICs, LED displays, sensors, SFPs, and/or optical transceivers for the user ports 511, the x-ports 513, or the like.

Each ASIC provides, among other functions, a switched or switchable datapath between a subset of the user ports 511 and the extender ports 513. For a stand-alone ported switch device, its extender ports can be cabled together with loopback cables (in an implementation hereof, each of the extender ports may be connected with a respective loopback cable to another extender port). For a stacked configuration, the extender ports of the ported devices are cabled together. For a racked configuration, the extender ports of the ported devices and the non-ported switch devices are cabled together. In one implementation, the extender ports are cabled using four parallel bi-directional optical fiber or high-speed copper links, although other configurations are contemplated.

Each processor may also have an embedded port through which it can access the switching system. The switching system views the embedded ports no differently than the front standard user ports, such that frames received at any front port on any ported switch device may be routed in hardware to the embedded port of any ported switch device processor on any ported switch device. Frames sent from the embedded port of any ported switch device may be transmitted out any user port, or may be received at an embedded port of any other ported switch device processor. Communications between processors of different ASICs of the same ported switch device as well as processors of different ported switch devices can communicate through the switching system with any other processor in the switch system.

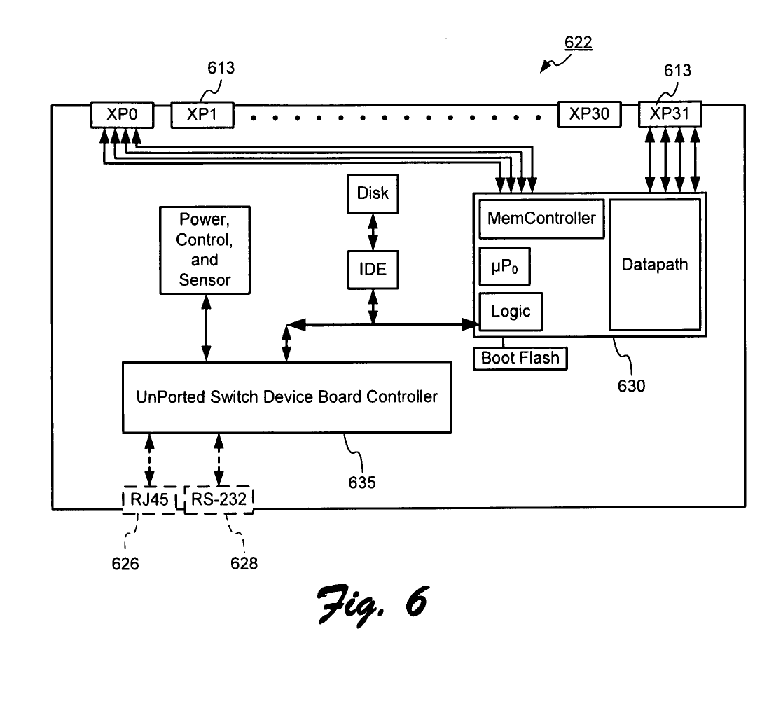

In contrast, as shown in FIG. 6 an exemplary architecture of a non-ported switch device 622 includes no standard front ports with only typically non-standard extender ports 613. The non-ported switch device 622 also includes one or two switch device ASICs, one ASIC 630 shown in FIG. 6, each of which switches cells between its extender ports. Each switch device ASIC contains or is otherwise associated with a processor core (called a switch intelligence processor or SIP, here shown as lP0). The unported switch device board controller 635 may include either or both of a management Ethernet interface 626 (RJ45) and a serial interface 628 (RS-232) (shown in dashed lines due to the optionality of their inclusion). Exemplary architectures can also include multiple processors for redundancy and performance, although single processor devices are also contemplated. A non-ported switch board controller 635 not unlike the board controller 535 (of the ported switch device of FIG. 5) may also be included, however, if only one ASIC is included then, the arbitration function thereof would not generally be necessary.

Communication between ported and non-ported devices of FIGS. 5 and 6 may take place via their extender port (XP) connections (see e.g., FIGS. 3 and 4). More specifically, the devices of a switch system may be interconnected via high-speed parallel optic transceivers (or their short haul copper equivalent) called extender ports and four lane bi-directional cables called XP links. Two discrete devices may normally be connected by at least one cable containing four or more bi-directional fibre pairs; user traffic enters and leaves the system as frames or packets but it transmits over the XP links in parallel as small cells, each with a payload of (approximately) 64 bytes to 128 bytes. As described further below, the XP links can also carry device-to-device control information in combination with user Fibre Channel and Ethernet data between ported switch devices and non-ported switch devices.

It should be understood that the hardware architectures illustrated in FIGS. 5 and 6 and described herein are merely exemplary and that ported switch devices and other switch devices ported or otherwise may take other forms.

Individual devices can include one or more subsystems, which are driven by firmware, hardware and/or software executed by individual processors in the switch. In one implementation, each flash memory in a device stores a full set of possible firmware components for all supported subsystems. Alternatively, firmware, hardware and/or software components can be distributed differently to different devices. In either configuration, each processor is assigned zero or more subsystems, such that a processor may load the firmware or software components for the assigned subsystems from flash memory and executes these components. In one implementation, a subsystem is cohesive in that it is designed for a specific function, and includes one or more independently-scheduled tasks. A subsystem need make no assumptions about its relative location (e.g., by which processor or which device its firmware or software is executed), although it can assume that another subsystem with which it interacts might be located on a different processor or device. A subsystem may also span multiple processors. For example, a Fibre Channel Name Server subsystem may execute on multiple processors in a switch. Subsystems may be independently loadable at initialization or run time and may communicate with each other by sending and receiving messages, which contributes to their location-independence. Furthermore, within a given processor's execution state, multiple subsystems can access a common set of global functions via a function call.

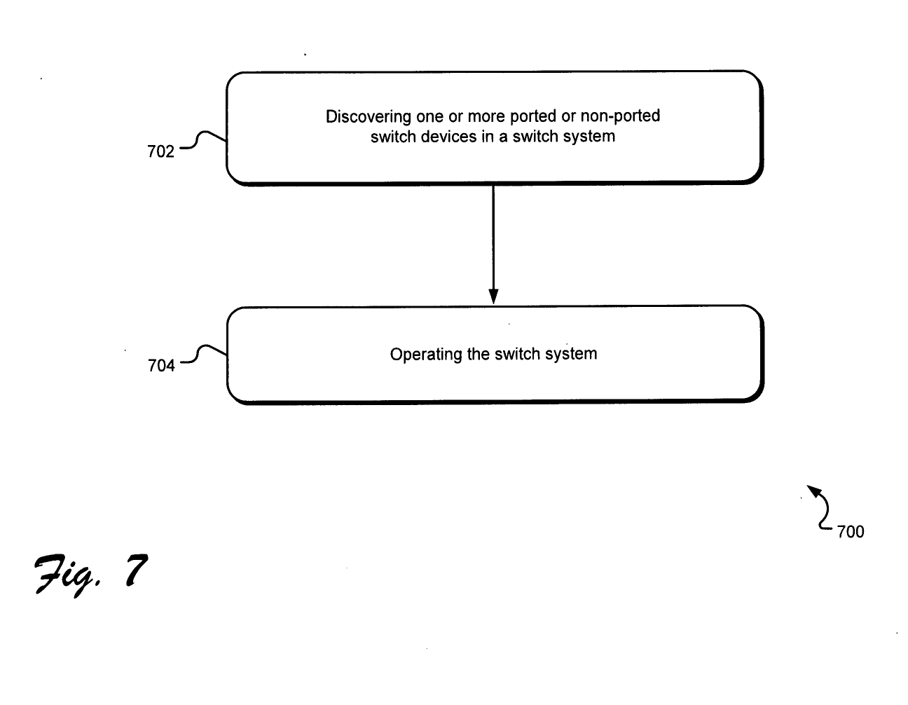

As introduced above and described in more detail below, an identification communication or discovery operation 702 of the more generally identified method 700 of managing a switch system in a computer network, see FIG. 7, may include a staged process in which the low-level processors in a switch and/or between switch devices exchange information, as for example, identification communications, in order to determine the number and types of devices connected in or to the switch device. In one implementation, a discovery facility within one or more of the microprocessor(s) μP0 and/or μP1 may provide this functionality, although other configurations are contemplated. Note, as described further below, such a discovery operation may be implemented by software, firmware and/or hardware options.

As introduced above, the connections of the ported and/or unported switch devices via the extender port (XP) links can carry device-to-device control information, as for example an identification communication, in combination with user Fibre Channel and Ethernet data between ported switch devices and non-ported switch devices. The discovery operation 702 may thereby involve the sending of an identification communication whether of the actual identification information of a device, and/or of sending a query to the device cabled to each of a device's extender ports and the receiving of identification information from the remote device, including for example a device ID, a device serial number, and/or a device type.

The transmission of user frames or packets may depend on the proper configuration, by for example embedded software, for forwarding tables implemented as content addressable memories (CAMs) and “cell spraying masks”, which indicate how the parallel lanes of the XP links are connected. Before the CAMs and masks can be properly programmed, subsystems executing in different devices discover one another, per operation 702, e.g., and determine how the XP links are attached. In one implementation, discovery is accomplished using single cell commands (SCCs), which are messages segmented into units of no more than a single cell and transmitted serially over a single lane of a single extender port, point-to-point. The SCCs may be identification communications, for example.

Devices may thus discover one another by the exchange of SCCs sent from each lane of each extender port. Following a successful handshake, e.g., after a successful exchange of SCCs, each device adds to its map of XP links that connect it with other devices. In the case of ported switch devices where there are two processor pairs, each processor pair can communicate via the PCI bus to which they are both connected, however, intra-device discovery may nevertheless be accomplished via the extender ports. Even so, in an alternative implementation, processors within the same device could use internal communication links for intra-device discovery.

In one stage of discovery, termed “self-” or “intra-device” discovery, a single processor in the device 530 will assume the role of device manager. The processor will query its counterpart on the same device to discover the other's presence, capabilities and/or health during intra-device discovery. Another stage is termed “inter-device” discovery, in which processors on different devices exchange information. Each processor sends and receives SCCs via each connected extender port to obtain the device ID and device serial number of the device on the other end of the cable.

The discovery process 702 may be complete in itself, or may include sub-processes such as including recognition of the connected devices, if any; it may include or be included in an initialization or handshaking operation between devices. There may be negotiations between devices and/or there may be agreement or disagreement involved as well. For example, there may be agreement or disagreement between two ported switch devices about the connection or recognition (or about some other part of the discovery) operation. There may be confirmation and/or verification operation(s), or there may be separate establishment operations. Or, any or all of these steps may be implicit within the discovery process itself, i.e., where a discovery request is sent by one device to another, there may be an implicit determination of the connection based upon the response or lack thereof. Thus, the discovery operation may itself establish to the satisfaction of the respective devices what is and how the connection of devices is accomplished so that operation of the switch system may commence.

As introduced above, the discovery process of the extender port connection(s) may be implemented by software, firmware or hardware (purely by logic gates) or a mixture of software, firmware and/or hardware as for example hardware with software assist. The SCC handshake procedure described above may be one form of software or firmware implementation. Otherwise, an automated or automatic health and topology detection system implemented in hardware or firmware may be as follows.

Each end of each extender port (XP) link may be configured with an identification tag (or ID) which identifies its location in the system. For some implementations, this ID may contain board slot number, ASIC device number, the link number and/or a software version identification. The software version identification may be useful to check for compatibility of the software and/or firmware for upgradeability and/or to determine whether the software and/or firmware of a relative two or more switch devices may be compatible for interconnectability. The identification tag may be sent, as for example an identification communication, by the ASIC (as for example by a transmitter portion thereof, if included) upon initial linkup. Each receiver is configured to be able to receive the transmitted ID from the remote side of the link. When received from the link, the received ID may be placed in a special register at the receiver. This register may be called the Remote ID register. Both ends of the link transmit their identification tag and receive from the remote side its identification tag and then place the received tag in its Remote ID register. To determine the topology of the system, i.e., to perform the discovery operation, the firmware (or hardware implementation with or without a software assist) can read the Remote IDs from all links. If the devices then agree that they have a legal connection, then they agree to form an interconnected single switch system. This scheme may also be used for health monitoring as well, particularly if the ID tags are configured to be transmitted at continuing intervals after linkup.

Once the discovery operation 702 has been completed, the operation 704 of the switch system may then be achieved (see FIG. 7). In this, frames may then be sent through the switch system including through the one or more ported switch devices and the zero or more non-ported switch devices which may make up the switch system. The discovery of links can contribute to the cell distribution and/or re-assembly process. More particularly, frames may be divided into cells, which may then be distributed through the switch system. These cells can then be re-assembled into frames at the destination ported switch device, and then sent to their respective destinations, whether in/to servers or storage devices.

Modular architectures according hereto may provide for one or more of high performance, scalability, configuration flexibility, and near-linear cost scaling (pay as you grow). Such results may come from streamlining the switch device building blocks to common modules or blocks which can be used to optionally build or create all ranges of switches from standalone switches, stackable switches, rackable directors (thus, small, medium, large, and very large options). These modules or blocks also provide for late binding of product family configurations to react to market and customer needs, as for example providing a low cost-of-entry to customers that want to start at the smallest or most economical configuration possible to save the initial deployment cost/budget, and yet also provide a near-linear pay-as-you-grow scaling and upgrades to meet variety of on-demand growths of customer applications. Avoiding the cost of one or more chassis reduces the cost bumps that currently occur. Also, the modular, or building blocks hereof can provide a cost efficient bill of materials (BOM) and manufacturing with consolidation of components and efficient streamlining of test flow.

The embodiments of the invention described herein may be implemented as logical steps in one or more computer or computer-related systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language. In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave or other communication media by a computing system and encoding the computer program.

The above specification, examples and data provide a complete description of the structure and use of exemplary implementations of. Since many implementations can be made without departing from the spirit and scope of the invention, the invention resides in the claims hereinafter appended. Furthermore, structural features of the different embodiments may be combined in yet another embodiment without departing from the recited claims.

What is claimed is:

1. A computer network ported switch device which is adapted to be operable as a switch system in an independent standalone mode as well as being adapted to be operable in conjunction with either or both of a discrete ported switch device and a discrete non-ported switch device; the ported switch device comprising:
a housing containing:
an ASIC providing a switching function within the ported switch device;
a plurality of standard ports communicating with the ASIC and being connectable to one or more external computer network devices;
a plurality of extender ports communicating with the ASIC and being connectable in one or more of to themselves in loopback fashion or to one or more ported or non-ported switch devices, whereby the extender ports operate on a discrete protocol from the standard ports;
whereby the ported switch device is adapted to be operable in either the independent standalone fashion or in conjunction with one or both of a discrete ported switch device and a discrete non-ported switch device;
whereby the ASIC is associated with the provision of identification communication via the extender ports to enable the ASIC to take part in the determination of the operable connection or absence of connection of the extender ports in one or more of to themselves in loopback fashion or to one or more ported or non-ported switch devices.

2. A computer network ported switch device according to claim 1 whereby the identification communication is adapted to provide for the determination of whether a legal connection exists on an extender port such that an agreement to form a single switch system may be obtained with any device connected to the extender port of the ported switch device.

3. A computer network ported switch device according to claim 1 whereby the identification communication is adapted to provide for the ported switch device to be operable in the independent standalone fashion or in conjunction with a discrete ported or non-ported switch device or any combination thereof whether discretely or substantially simultaneously connected.

4. A computer network ported switch device according to claim 1 wherein the ported switch device further comprises one or any combination of software, hardware or firmware operably associated with, connected to or within the ASIC, the software, hardware or firmware or any combination thereof being adapted to provide the identification communication for the ported switch device.

5. A computer network ported switch device according to claim 1 wherein the ported switch device further comprises one or any combination of software, hardware or firmware operable with or within the ASIC to provide discovery of connections to the extender ports.

6. A computer network ported switch device according to claim 1 wherein the ported switch device further comprises one or any combination of software, hardware or firmware operable with or within the ASIC to provide discovery of connections to the extender ports, the discovery being one or more of auto-discovery, inter-device discovery, intra-device discovery, and self-discovery.

7. A computer network ported switch device according to claim 1 wherein the ported switch device further comprises one or any combination of software, hardware or firmware operable with or within the ASIC to provide discovery of connections to the extender ports, the discovery providing for the ported switch device to be operable in either the standalone fashion or in conjunction with a discrete non-ported switch device.

8. A computer network ported switch device according to claim 1 further comprising a total of at least two ASICs creating a switching system within the ported switch device.

9. A computer network ported switch device according to claim 1 further comprising a total of at least two ASICs creating a switching system within the ported switch device, and further comprising a board controller connected to the at least two ASICs.

10. A computer network non-ported switch device which is adapted to be operable as a switch system in conjunction with at least one discrete ported switch device; the non-ported switch device comprising:
a housing containing:
an ASIC providing a switching system within the non-ported switch device;
a plurality of extender ports communicating with the ASIC and being connectable to one or more ported or non-ported switch devices, whereby the extender ports operate on a discrete protocol from the standard ports of a ported switch device;
whereby the ASIC is associated with the provision of identification communication via the extender ports to enable the ASIC to take part in the determination of the operable connection or absence of connection of the extender ports to one or more ported or non-ported switch devices.

11. A computer network non-ported switch device according to claim 10 whereby the identification communication is adapted to provide for the determination of whether a legal connection exists on an extender port such that an agreement to form a single switch system may be obtained with the device connected to the extender port of the non-ported switch device.

12. A computer network non-ported switch device according to claim 10 wherein the non-ported switch device further comprises one or any combination of software, hardware or firmware to provide one or both of the identification communication via and discovery of connections to the extender ports.

13. A computer network non-ported switch device according to claim 10 wherein the non-ported switch device further comprises one or any combination of software, hardware or firmware to provide discovery of connections to the extender ports, the discovery being one or more of auto-discovery, inter-device discovery, intra-device discovery, and self-discovery.

14. A computer network non-ported switch device according to claim 10 further comprising a total of at least two ASICs creating a switching system within the non-ported switch device.

15. A computer network non-ported switch device according to claim 10 further comprising a total of at least two ASICs creating a switching system within the non-ported switch device, and further comprising a board controller connected to the at least two ASICs.

16. A computer network system comprising:
a switch system including at least one ported switch device and at least one non-ported switch device connected to each other; whereby the ported switch device is adapted to be operable either as a switch system in an independent standalone mode or in conjunction with another ported switch device or the non-ported switch device; and whereby the non-ported switch device is adapted to be operable in conjunction with the ported switch device;
the ported switch device including:
a housing containing:
a ported device ASIC creating a switching system within the ported switch device;
a plurality of standard ports communicating with the ported device ASIC and being connectable to one or more external computer network devices;
a plurality of extender ports communicating with the ported device ASIC and being adapted to be connectable in one or more of to themselves in loopback fashion or to one or more ported or non-ported switch devices, whereby the extender ports operate on a discrete protocol from the standard ports;
the non-ported switch device including:
a housing containing:
a non-ported device ASIC creating a switching system within the non-ported switch device;
a plurality of extender ports communicating with the non-ported device ASIC and being connectable to one or more ported or non-ported switch devices, whereby the extender ports operate on a discrete protocol from the standard ports of the ported switch device;
whereby the ported switch device is connected to the non-ported switch device via the respective extender ports thereof;
whereby the respective ported and non-ported ASICS are associated with the provision of identification communication via the extender ports to enable the determination of the operable connection or absence of connection of the extender ports of the ported and non-ported switch devices.

17. A computer network system according to claim 16 further including:
at least one computer server;
at least one storage device; and
wherein the switch system connects the at least one computer server with the at least one storage device; and
wherein the switch system provides for transmitting frames between the at least one computer server and the at least one storage device.

18. A method of managing a switch system in a computer network, the switch system containing one or more ported switch devices and zero or more non-ported switch devices, the method comprising:
discovering one or more ported or non-ported switch devices via any connections extant therebetween; and
operating the switch system;
wherein the operating of the switch system includes one of operating one of the one or more ported switch devices in an independent standalone mode and operating the one or more ported switch devices in conjunction with the zero or more non-ported switch devices.

19. A method according to claim 18 wherein the discovering operation includes one or more of the sending or receiving of an identification communication.

20. A method according to claim 18 wherein the discovering operation includes one or more of: recognition of the connected devices, if any; initialization or handshaking between devices; negotiation between devices; agreement or disagreement between devices; confirmation, verification, or establishment communication between devices; sending of a discovery request by one device to another; sending of a response communication by one device to another; determination of a connection based upon a sent response communication; or determination of a lack of a connection based upon a lack of a received response communication; and establishment between two respective devices what is and how the connection of the devices is accomplished so that operation of the switch system may commence.
